(19) United States
(12) Patent Application Publication
(10) Pub. No.: US 2009/0207260 A1
(43) Pub. Date: Aug. 20, 2009

(54) IMAGE PICKUP APPARATUS AND IMAGE PICKUP METHOD

(75) Inventor: Eiji Furukawa, Saitama-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 12/365,476

(22) Filed: Feb. 4, 2009

(30) Foreign Application Priority Data
Feb. 7, 2008 (JP) 2008-28029

(51) Int. Cl. H04N 5/228

(52) U.S. Cl. 348/208.4; 348/E05.031

(57) ABSTRACT

An image pickup apparatus includes: a flash photography unit that performs image pickup of one of the plurality of images by causing a flash device to emit light during the image pickup in accordance with an exposure; a region setting unit for setting a plurality of motion vector measurement regions for which a motion vector is measured; a motion vector reliability calculation unit for calculating a reliability of respective motion vectors; and a main region detection unit for detecting a main region from the image photographed by the flash photography unit. A motion vector integration processing unit includes a contribution calculation unit for calculating a contribution of the respective motion vectors from a positional relationship between the respective motion vector measurement regions and the main region, and integrates the motion vectors of the plurality of motion vector measurement regions in accordance with the reliability and the contribution.

### TECHNICAL FIELD OF THE INVENTION

This invention relates to an image pickup apparatus and an image pickup method with which to perform registration processing between a plurality of images, and more particularly to an image pickup apparatus and an image pickup method with which to perform registration processing that is used when images are superimposed during image blur correction and the like.

### BACKGROUND OF THE INVENTION

A block matching method or a correlation method based on a correlation calculation is known as a conventional method of detecting a motion vector of an image during image blur correction and the like.

In the block matching method, an input image signal is divided into a plurality of blocks of an appropriate size (for example, 8 pixels×8 lines), and a difference in pixel value between a current field (or frame) and a previous field is calculated in block units. Further, on the basis of this difference, a block of the previous field that has a high correlation to a certain block of the current field is searched for. A relative displacement between the two blocks is then set as the motion vector of the certain block.

In a method of searching for a block having a high correlation during block matching, the correlation is evaluated using a sum of squared difference SSD, which is the sum of squares of the pixel value difference, and a sum of absolute difference SAD, which is the absolute value sum of the pixel value difference. As SSD and SAD decrease, the correlation is evaluated to be higher. When a pixel position within a matching reference block region I of the current field is represented by p, a pixel position (a position corresponding to the pixel position p) within a subject block region I′ of the previous field is represented by q, and the pixel values of the pixel positions p, q are represented by Lp, Lq, respectively, SSD and SAD are respectively expressed by the following Equations (1) and (2).

$$\begin{matrix}SSD ( I , {I}^{′} ) = {\sum }_{p ∈ I , q ∈ {I}^{′}} {( Lp - Lq )}^{2} & ( 1 ) \\ SAD ( I , {I}^{′} ) = {\sum }_{p ∈ I , q ∈ {I}^{′}} ‖ Lp - Lq ‖ & ( 2 )\end{matrix}$$

Here, p and q are quantities having two-dimensional values. I and I′ represent two-dimensional regions of the current field and the previous field, respectively. The term pεI indicates that the coordinate p is included in the region I, and the term qεI′ indicates that the coordinate q is included in the region I′.

Meanwhile, in the correlation method based on a correlation calculation, average values Ave (Lp), Ave (Lq) of the pixels pεI and qεI′ respectively included in the matching reference block region I and the subject block region I′ are calculated. A difference between the pixel value included in each block and the average value is then calculated using the following Equation (3).

$$\begin{matrix}{{Lp}^{′} = \frac{Lp - Ave ( Lp )}{\sqrt{\frac{1}{n} {\sum }_{p ∈ I} {( Lp - Ave ( Lp ) )}^{2}}} \vert}_{p ∈ I} \\ {{Lq}^{′} = \frac{Lq - Ave ( Lq )}{\sqrt{\frac{1}{n} {\sum }_{q ∈ I} {( Lq - Ave ( Lq ) )}^{2}}} \vert}_{q ∈ {I}^{′}}\end{matrix} \qquad ( 3 )$$

Next, a normalization cross-correlation NCC is calculated using Equation (4).

NCC=ΣLp′Lq′ (4)

A block having a large normalization cross-correlation NCC is evaluated as having a high correlation, and the displacement between the blocks I′ and I having the highest correlation is set as the motion vector.

When an object or an image pickup subject included in an image is stationary, the motion within individual regions and the motion of the entire image match, and therefore the motion vector may be calculated by disposing the block in which the correlation calculation is to be performed in an arbitrary fixed position.

It should be noted that in certain cases, it may be impossible to obtain a highly reliable motion vector due to the effects of noise or when the block is applied to a flat portion or an edge portion having a larger structure than the block. To prevent such cases from arising, a technique for performing a reliability determination during calculation of the motion vector is disclosed in JP8-163573A and JP3164121B, for example.

Further, when the object or image pickup subject included in the image includes a plurality of motions, it is necessary to calculate the motion vector of the entire image in order to correct blur, for example. In JP8-251474A, the object is divided into a plurality of regions, and an important region is selected from the plurality of regions in accordance with the magnitude of the motion vector, the size of the region, and so on. The motion vector of the selected region is then set as the motion of the entire image.

In this case, region selecting means (i) select the region having the largest range from the plurality of regions, (ii) select the region having the smallest motion vector from the plurality of regions, (iii) select the region having the largest range of overlap with a previously selected region from the plurality of regions, and (iv) select one of the region having the largest range, the region having the smallest motion vector, and the region having the largest range of overlap with the previously selected region.

### SUMMARY OF THE INVENTION

An aspect of this invention provides an image pickup apparatus that performs image registration processing between a plurality of images using a motion vector calculation. The image processing apparatus includes: an exposure calculation unit for calculating an exposure when an object is photographed; a flash photography unit for performing image pickup of one of the plurality of images by causing a flash device to emit light during the image pickup in accordance with the exposure; a motion vector measurement region setting unit for setting a plurality of motion vector measurement regions for which a motion vector is measured; a motion vector calculation unit for calculating the motion vectors of the plurality of motion vector measurement regions; a motion vector reliability calculation unit for calculating a reliability of the respective motion vectors; a main region detection unit for detecting a main region from the image photographed by the flash photography unit; and a motion vector integration processing unit for calculating an inter-image correction vector on the basis of the motion vectors of the plurality of motion vector measurement regions, taking into account the reliability. The motion vector integration processing unit includes a contribution calculation unit for calculating a contribution of the respective motion vectors from a positional relationship between the respective motion vector measurement regions and the main region, and integrates the motion vectors of the plurality of motion vector measurement regions in accordance with the reliability and the contribution.

### BRIEF DESCRIPTION OF THE DRAWINGS

FIG. 1 is a block diagram showing an example of the constitution of an image pickup apparatus according to a first embodiment.

FIGS. 2A-2D are time charts showing a shutter signal, an AF lock signal, a strobo-light emission signal, and a writing signal for writing an image to a frame memory, respectively.

FIGS. 2E-2H are other time charts showing a shutter signal, an AF lock signal, a strobo-light emission signal, and a writing signal for writing an image to a frame memory, respectively.

FIG. 3 is a block diagram showing the constitution of a motion vector integration processing unit.

FIG. 4 is a flowchart showing an example of contribution calculation processing.

FIG. 5 is a flowchart showing another example of contribution calculation processing.

FIG. 6 is a flowchart showing an example of processing (correction vector calculation) performed by an integration calculation processing unit of the motion vector integration processing unit.

FIG. 7 is a view showing creation of a motion vector histogram according to a second embodiment.

FIG. 8 is a flowchart showing an example of processing (correction vector calculation) performed by a motion vector integration processing unit according to the second embodiment.

FIG. 9 is a block diagram showing the constitution of an image pickup apparatus according to a third embodiment.

FIGS. 10A-10C are views showing setting of a main region according to the third embodiment.

FIG. 11 is a block diagram showing the constitution of an image pickup apparatus according to a fourth embodiment.

FIGS. 12A-12C are views showing setting of a main region according to the fourth embodiment.

### DESCRIPTION OF THE PREFERRED EMBODIMENTS

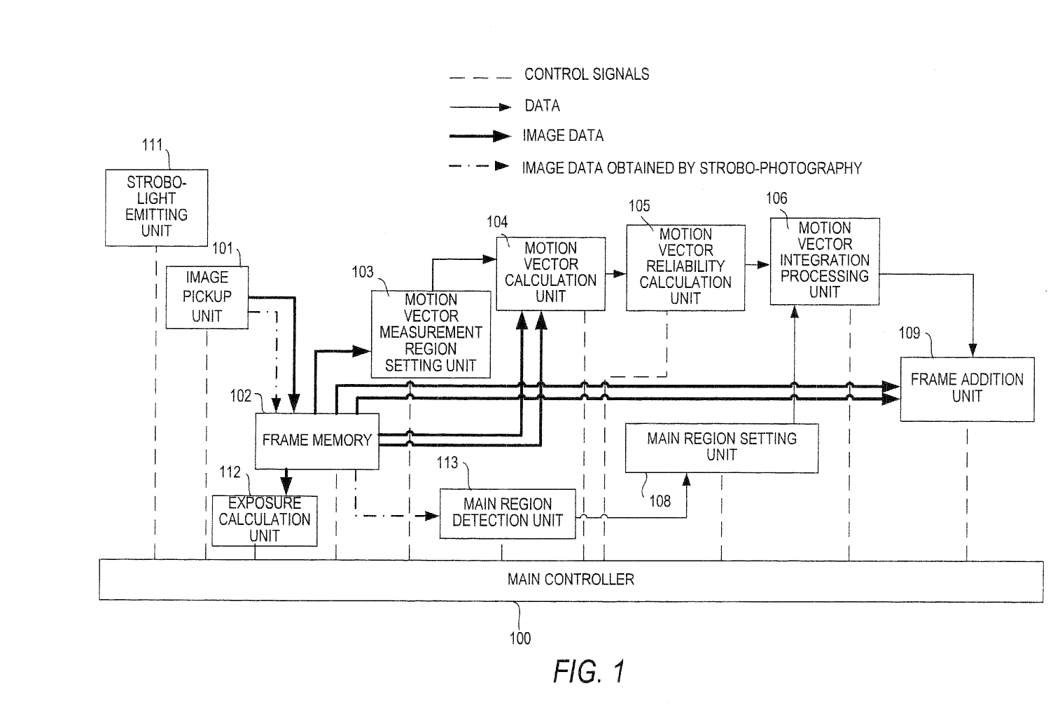

Referring to FIG. 1, a first embodiment will be described. FIG. 1 shows an image pickup apparatus that performs image registration and addition processing by calculating inter-frame motion. In this embodiment, the image pickup apparatus is an electronic camera.

A main controller 100 performs overall operation control, and includes a CPU such as a DSP (Digital Signal Processor), for example. In FIG. 1, dotted lines denote control signals, dot-dash lines denote the flow of image data obtained by strobo-photography (image pickup using flash light), thin lines denote the flow of data such as motion vectors and reliability values, and thick lines denote the flow of image data. The respective units (or the whole) of the image processing apparatus, to be described below, may be constituted by a logic circuit. Alternatively, the respective units (or the whole) of the image processing apparatus, to be described below, may be constituted by a memory that stores data, a memory that stores a calculation program, a CPU (Central Processing Unit) that executes the calculation program, an input/output interface, and so on.

A plurality of images input from the image pickup unit 101 through continuous shooting (continuous image pickup) or the like are all stored in a frame memory 102. The image pickup unit 101 that obtains the images is constituted by a lens system, an imaging device such as a CCD (charge coupled device) array, and so on. An exposure calculation unit (exposure calculating means) 112 calculates an exposure of the imaging device when an object is photographed on the basis of data relating to luminance values (pixel values) of the images stored in the frame memory 102.

A strobo-light emitting unit 111 (flash device) emits a flash that illuminates the object during image pickup. The main controller 100 controls the strobo-light emitting unit 111 such that the strobo-light emitting unit 111 emits light in accordance with the calculated exposure. More specifically, the main controller 100 causes the strobo-light emitting unit 111 to emit light only when the calculated exposure is equal to or smaller than a threshold. Further, when the strobo-light emitting unit 111 emits light, the main controller 100 may adjust a light emission amount of the strobo-light emitting unit 111 in accordance with the calculated exposure. The image pickup unit 101, main controller 100, and strobo-light emitting unit 111 constitute a flash photography unit.

The strobo-photographed image data are stored temporarily in the frame memory 102 from the image pickup unit 101. A main region detection unit 113 then detects a main region (a region of a main object or the like). Position information data relating to the detected main region are then transmitted to a main region setting unit 108. Here, the main region position information data may be data indicating a reference frame block corresponding to the main region or the like.

A region setting unit 103 sets predetermined motion vector measurement regions for a reference frame (reference image) stored in the frame memory as a reference in order to calculate motion between the reference frame and a subject frame (subject image). The region setting unit 103 sets block regions (motion vector measurement blocks) in lattice form in the reference frame as motion vector measurement regions. A motion vector calculation unit 104 uses the image data of the reference frame and the subject frame stored in the frame memory and data relating to the block regions set by the region setting unit 103. Thus, the motion vector calculation unit 104 calculates a block region position of the subject frame having a high correlation with a block region of the reference frame using a correlation calculation of a sum of squared difference SSD, a sum of absolute difference SAD, a normalization cross-correlation NCC, and so on. A relative displacement between the block region of the reference frame and the block region of the subject frame is then calculated as a motion vector.

A motion vector reliability calculation unit 105 calculates the reliability of the motion vector. The main region setting unit 108 sets main region position information (centroid coordinate, size, and so on) on the basis of the position information (the reference frame block corresponding to the main region and so on) from the main region detection unit 113. A motion vector integration processing unit 106 calculates a representative value (correction vector) of an inter-frame motion vector by integrating motion vector data in accordance with a positional relationship between the block regions and the main region of the reference frame. A frame addition unit 109 performs frame addition using the image data of the reference frame and the subject frame stored in the frame memory and data relating to the correction vector.

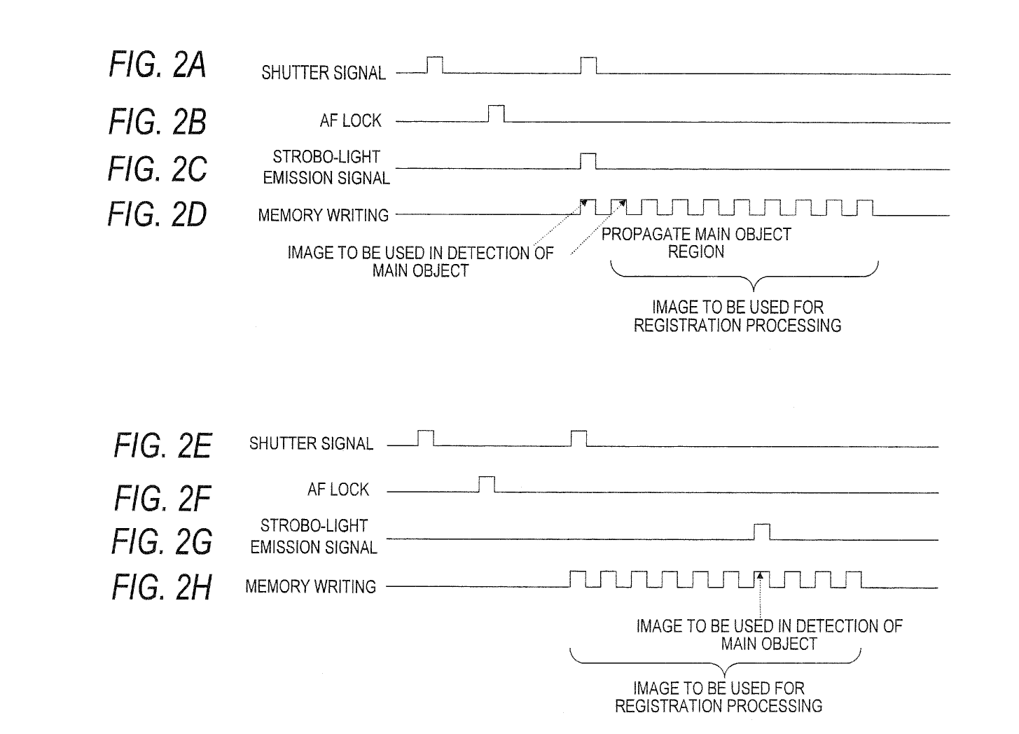

Next, referring to FIGS. 2A-2D and FIGS. 2E-2H, examples of methods for obtaining an image for main region detection (a strobo-photographed image) and a reference image from the plurality of images will be described. FIGS. 2A-2D and FIGS. 2E-2H are time charts showing a shutter signal, an AF lock signal, a strobo-light emission signal, and a writing signal for writing an image to the frame memory.

In the example shown in FIGS. 2A-2D, when a user half-presses a shutter button (not shown) and then fully presses the shutter button following locking of an AF (automatic focus mechanism), continuous shooting for obtaining a plurality of images is begun, and during pickup of the first image, strobo-light is emitted. The image to be used in detection of the main region is the first image captured when the strobo-light is emitted. The main region detection unit 113 detects the main region from the first image, and transmits position information relating thereto to the main region setting unit 108. Further, an image other than the first image (a subsequent second image or the like) is used as a reference frame so that the position information can be propagated to the other image. The main region setting unit 108 sets a main region in a region of the reference frame that corresponds to the main region of the first image. The motion vector integration processing unit 106 calculates an inter-image correction vector for correcting blur and so on in relation to the main region of the reference frame, for the plurality of images other than the first image obtained through strobo-photography. It should be noted that the first image used to detect the main region has a greatly increased luminance in comparison with the other images due to the emission of strobo-light, and cannot therefore be compared with the other images. Hence, a motion vector cannot be calculated for the first image through block matching or the like. Therefore, the first image is used only to detect the main region, and is not used in blur correction and so on.

When the exposure immediately before the start of continuous shooting is detected to be equal to or smaller than the threshold in the above description, the main controller 100 may control the strobo-light emitting unit 111 to emit strobo-light during pickup of the first image at the start of the continuous shooting.

In the example shown in FIGS. 2E-2H, when the user half-presses the shutter and then fully presses the shutter following locking of the AF, continuous shooting for obtaining a plurality of images is begun, and during pickup of a seventh image midway through the continuous shooting, strobo-light is emitted. The image to be used in main region detection is the seventh image captured when the strobo-light is emitted. The main region detection unit 113 detects the main region from the seventh image, and transmits position information relating thereto to the main region setting unit 108. When a difference in exposure (luminance value) between the seventh image and the other images is small, the seventh image is used as the reference frame. The motion vector integration processing unit 106 detects an inter-image correction vector for correcting blur in relation to the plurality of images obtained through continuous shooting, including the seventh image used to detect the main region, using the seventh image as the reference frame.

Further, when the difference in exposure (luminance value) between the seventh image and the other images is large, the main region position information is propagated to an image other than the seventh image, similarly to the example shown in FIGS. 2A-2D. The main region setting unit 108 then sets a main region in a region of the reference frame that corresponds to the main region of the seventh image, using an image other than the seventh image (a preceding sixth image or a following eighth image or the like) as the reference frame. The motion vector integration processing unit 106 then detects an inter-image correction vector for correcting blur and so on, using the image other than the seventh image.

When the exposure immediately before the start of continuous shooting is detected to be equal to or smaller than the threshold, the main controller 100 may perform advance setting such that strobo-light is emitted during pickup of a predetermined image (the seventh image). Alternatively, when the exposure immediately before pickup of the predetermined image (the seventh image) is detected to be equal to or smaller than the threshold midway through the continuous shooting, the main controller 100 may cause strobo-light to be emitted during pickup of the predetermined image (the seventh image).

Next, an outline of an operation for calculating the reliability of the motion vector, which is performed by the motion vector reliability calculation unit 105, will be described.

A method of determining the reliability of the motion vector on the basis of the statistical property of an inter-frame (inter-image) correlation value in block units and a method of determining the reliability of the motion vector on the basis of the statistical property of a correlation value within a frame are known.

When the reliability is determined on the basis of the statistical property of the inter-frame correlation value, a sum of squares SSD (expressed by the following Equation (5)) of a difference between pixel values included in a block Ii of the reference frame (reference image) and a block Ij of the subject frame (subject image), for example, is used as a correlation value between the motion vector measurement region of the reference frame and a corresponding image region of the subject frame.

$$\begin{matrix}SSD ( i , j ) = {\sum }_{p ∈ Ii , q ∈ Ij} {( Lp - Lq )}^{2} \\ Ii = \{ \begin{matrix}x ∈ ( bxi = \frac{1}{2} h , bxi + \frac{1}{2} h ) \\ y ∈ ( byi - \frac{1}{2} v , byi + \frac{1}{2} v )\end{matrix} \\ Ij = \{ \begin{matrix}x ∈ ( bxi + bxj - \frac{1}{2} h , bxi + bxj + \frac{1}{2} h ) \\ y ∈ ( byi + byj - \frac{1}{2} v , byi + byj + \frac{1}{2} v )\end{matrix}\end{matrix} \qquad ( 5 )$$

Here, coordinates (bxi, byi) denote a centroid position (or a central coordinate) of an ith block set by the region setting unit 103, and are prepared in a number corresponding to the number of blocks Ii. The symbols “h”, “v” represent the dimension of the block in a horizontal direction and a vertical direction, respectively. Coordinates (bxj, byj) denote a centroid position of a jth subject block Ij, and are prepared in accordance with a block matching search range.

The SSD (i, j) of the ith block takes various values depending on the number j of the subject block, whereas a reliability Si of the ith block is determined on the basis of a difference between a minimum value and an average value of the SSD (i, j). The reliability Si may simply be considered as the difference between the minimum value and the average value of the SSD (i, j).

The reliability based on the statistical property of the correlation value SSD corresponds to the structural features of the region through the following concepts. (i) In a region having a sharp edge structure, the reliability of the motion vector is high, and as a result, few errors occur in the subject block position exhibiting the minimum value of the SSD. When a histogram of the SSD is created, small SSD values are concentrated in the vicinity of the position exhibiting the minimum value. Accordingly, the difference between the minimum value and average value of the SSD is large. (ii) In the case of a textured or flat structure, the SSD histogram is flat, and as a result, the difference between the minimum value and average value of the SSD is small. Hence, the reliability is low. (iii) In the case of a repeating structure, the positions exhibiting the minimum value and a maximum value of the SSD are close, and positions exhibiting a small SSD value are dispersed. As a result, the difference between the minimum value and the average value is small, and the reliability is low. Thus, a highly reliable motion vector for the ith block is selected on the basis of the difference between the minimum value and the average value of the SSD (i, j).

When the reliability is determined on the basis of the statistical property of a correlation value within a frame, a correlation value between one motion vector measurement region of the reference image and another motion vector measurement region of the reference image is calculated, and the reliability Si is calculated on the basis of a minimum value of the correlation value (see JP2005-260481A).

It should be noted that the reliability may also be determined in accordance with an edge quantity of each block, as described in JP3164121B.

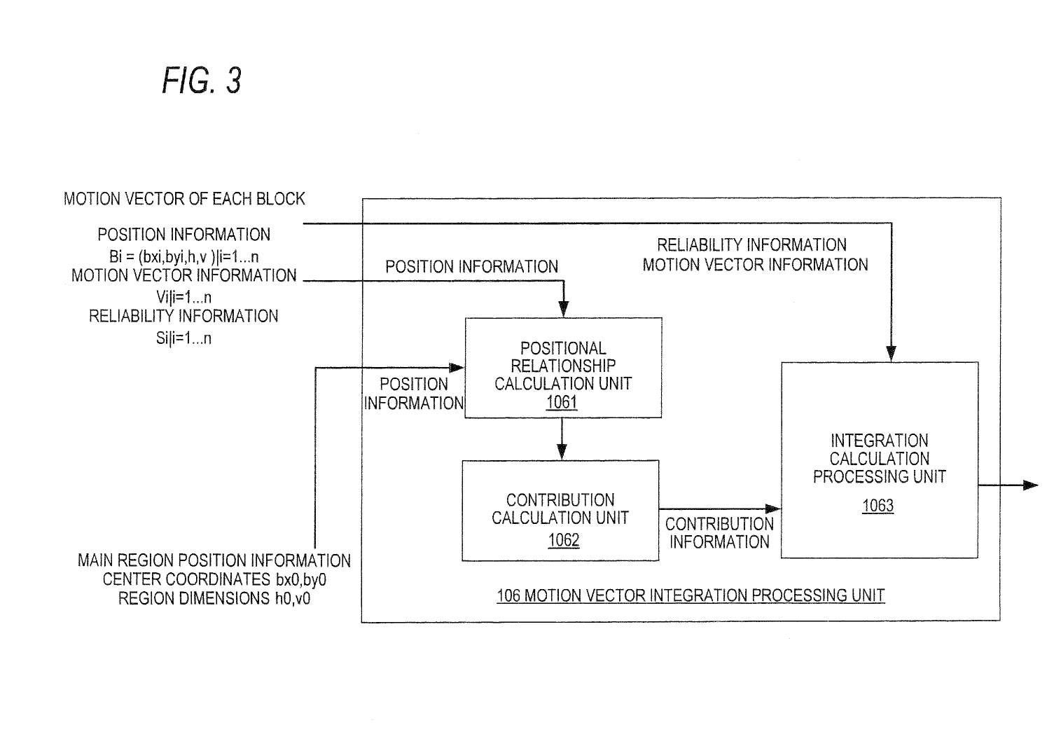

FIG. 3 shows in detail the constitution of the motion vector integration processing unit 106. A positional relationship calculation unit 1061 calculates a positional relationship using position information (centroid coordinates (bx0, by0) and the region dimensions h0, v0) relating to the main region and position information (centroid coordinates (bxi, byi) and the region magnitude h, v) relating to the motion vector measurement regions. A contribution calculation unit 1062 calculates a contribution of the motion vector of the respective motion vector measurement regions using the positional relationship information.

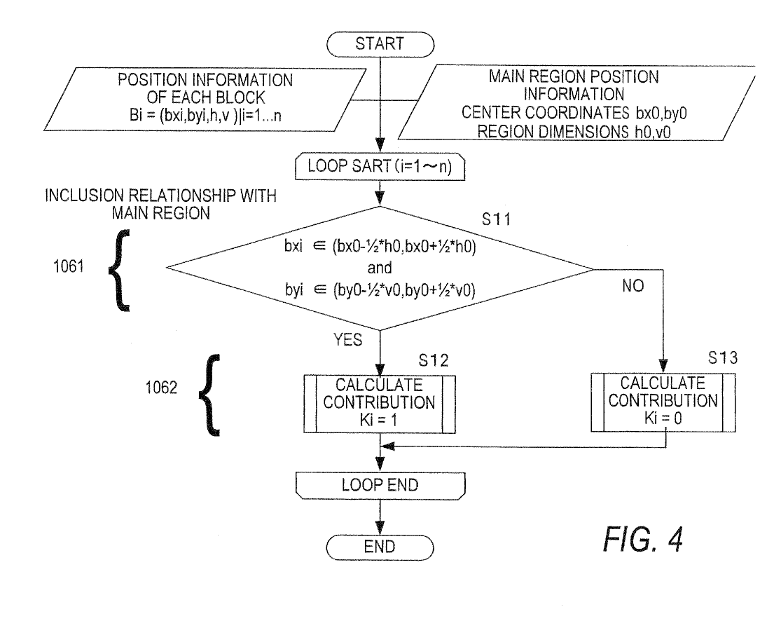

FIG. 4 shows a flowchart for calculating the contribution using an inclusion relationship between the motion vector measurement regions and the main region. First, a determination is made as to whether or not the centroid coordinates (bxi, byi) of the ith motion vector measurement region (motion vector measurement block) are included in the main region using the following Equation (6) (S11).

$$\begin{matrix}bxi ∈ ( bx 0 - \frac{1}{2} h 0 , bx 0 + \frac{1}{2} h 0 ) & ( 6 ) \\ and & \\ byi ∈ ( by 0 - \frac{1}{2} v0 , by 0 + \frac{1}{2} v 0 ) & \end{matrix}$$

When an affirmative result is obtained, 1 is set as a contribution Ki (Ki=1) (S12), and when a negative result is obtained, 0 is set as the contribution Ki (Ki=0) (S13).

Further, as a modified example of the contribution calculation described above, threshold processing may be performed in accordance with an area of overlap between the main region and the ith motion vector measurement region. More specifically, if the area of overlap between the main region and the ith motion vector measurement block is equal to or greater than a predetermined value, Ki=1 is set, and if not, Ki=0 is set.

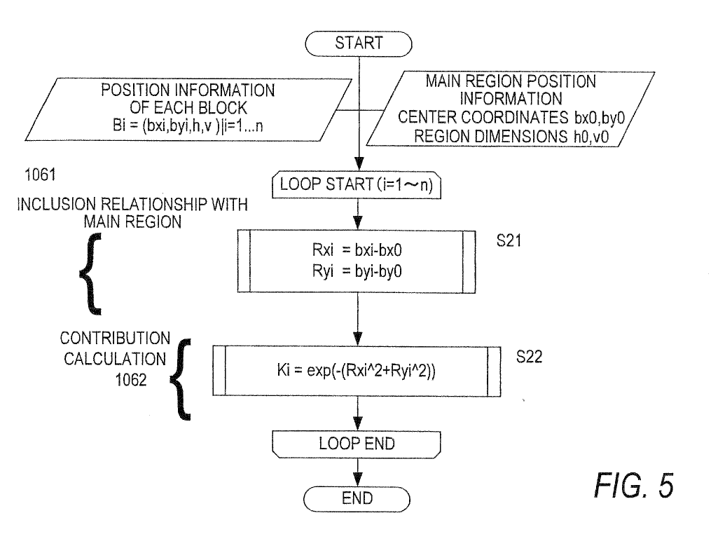

FIG. 5 shows a flowchart for calculating the contribution using another method. A distance between the main region and the respective motion vector measurement regions (a distance between the centroid coordinates thereof) is calculated using the following Equation (7) (S21). The contribution is then calculated in accordance with a function (Equation (8)) whereby the contribution decreases as the square of the distance increases (S22).

$$\begin{matrix}\begin{matrix}Rxi = bxi - bx 0 \\ Ryi = byi - by 0\end{matrix} & ( 7 ) \\ Ki = exp ( - C ( {Rxi}^{2} + {Ryi}^{2} ) ) & ( 8 )\end{matrix}$$

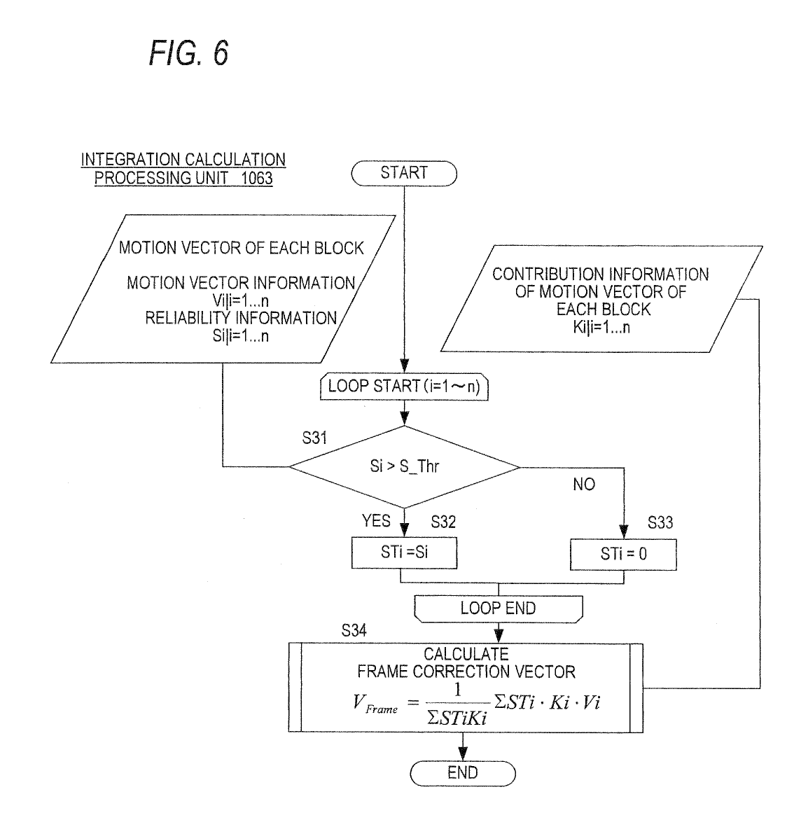

FIG. 6 shows a flowchart of processing performed by an integration calculation processing unit 1063. In a step S31, threshold processing is performed in relation to the reliability Si to determine whether or not the reliability Si is greater than a threshold S_Thr. A final reliability STi used to calculate a correction vector V_{frame} is determined by leaving the contribution of a block in which the reliability Si is greater than the threshold as is (S32) and setting the contribution of a block in which the reliability Si is equal to or smaller than the threshold at 0 (S33). As a result, the integration result of the motion vector is stabilized.

A frame correction vector V_{frame} is calculated by performing weighted addition on (or calculating a weighted average of) the motion vectors of the plurality of motion vector measurement regions using the final reliability STi, the contribution Ki, and a measurement result Vi of the motion vector of the ith motion vector measurement region in accordance with Equation (9) (S34).

$${V}_{Frame} = \frac{1}{Σ STiKi} Σ STi \cdot Ki \cdot Vi \qquad ( 9 )$$

Here, the denominator on the right side is a normalization coefficient. A weighting coefficient STiKi is set in accordance with the product of the reliability STi and the contribution Ki.

It should be noted that in the above description, the main region setting unit 108 sets the main region position in the image obtained when strobo-light is emitted using main object position information, which is obtained by the main region detection unit 113 on the basis of object recognition (well-known face recognition, for example) or contrast intensity.

As another modified example, a motion vector may be calculated in relation to a pre-selected region using the information from the main region setting unit 108 and the information from the motion vector measurement region setting unit 103, and the correction vector may be calculated by integrating the data relating to the motion vector in accordance with the reliability of the region.

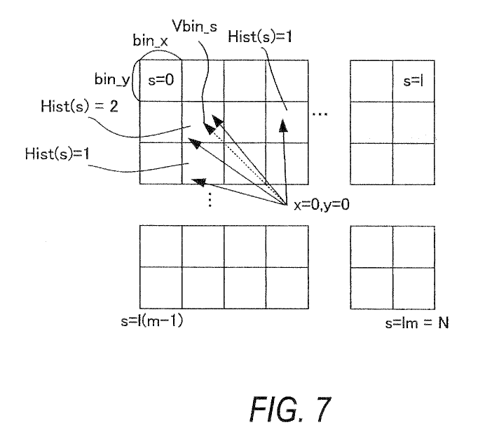

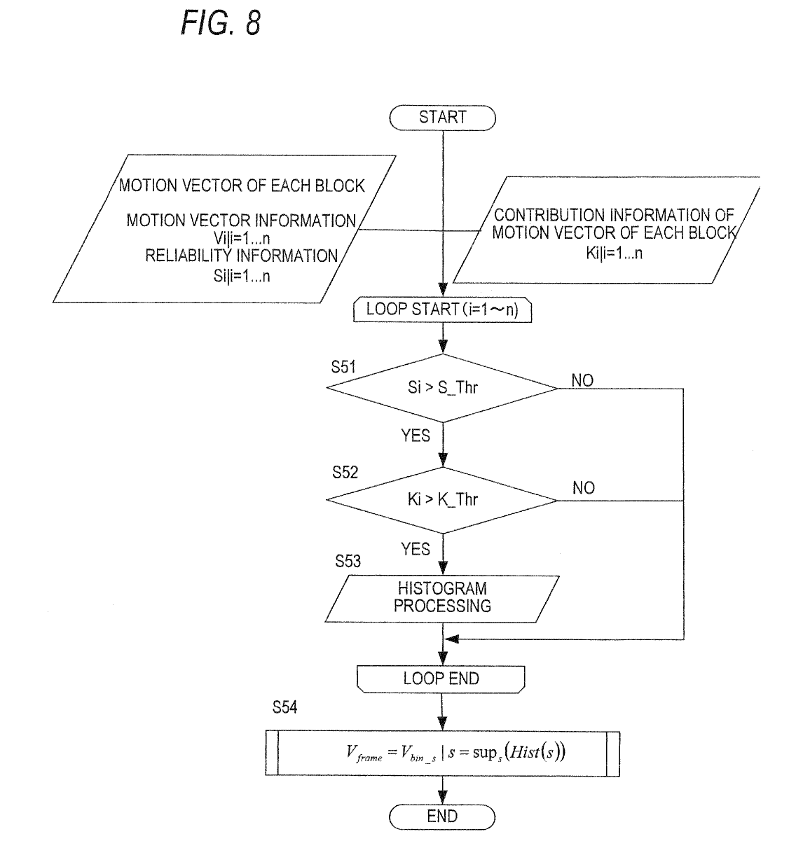

Next, a second embodiment will be described with reference to FIGS. 7 and 8. In the first embodiment described above, the correction vector is determined by weighted addition (Equation (9)), but in the second embodiment, a different method is employed. In the second embodiment, histogram processing is performed in relation to a motion vector Vi (Equation (10)) in which the reliability Si is equal to or greater than the threshold S_Thr and the contribution Ki is equal to or greater than a predetermined value K_Thr, whereupon vector quantities (orientation and magnitude) are divided into appropriate bins and a vector having a high frequency is employed as the correction vector.

$$Vi = ( {x}_{i} , {y}_{i} ) \vert \begin{matrix}Si > S\_Thr \\ Ki > K\_Thr\end{matrix} \qquad ( 10 )$$

Here, a bin is a dividing region or class in the histogram (or frequency distribution). A width of the bin in an x axis direction is bin_x, and a width of the bin in a y axis direction is bin_y.

As shown in FIG. 7, when the horizontal/vertical direction coordinates of the motion vector are set as x, y and x, y enter an sth (s=0 . . . N|(N=1×m)) bin, the frequency of the bin is increased by 1. It should be noted that the bin number s is obtained from the position on the coordinates using Equation (11).

$$\begin{matrix}{x}^{′} = floor ( x / bin\_x ) \\ {y}^{′} = floor ( y / bin\_y ) \\ s = {x}^{′} + {y}^{′} \cdot l\end{matrix} \qquad ( 11 )$$

Here, floor is a floor function. Further, “1” denotes a horizontal direction range in which the histogram is created, and “m” denotes a vertical direction range in which the histogram is created.

The bin frequency is counted by increasing a frequency Hist(s) of the sth bin every time the motion vector Vi enters the sth bin, as shown in Equation (12).

Hist(s)=Hist(s)+1 (12)

This count is performed in relation to all of the motion vectors Vi for which Si is equal to or greater than S_Thr and Ki is equal to or greater than K_Thr.

FIG. 7 shows a bin arrangement for determining a vector histogram and the manner in which the number Hist(s) of vectors entering the bin is counted using the processing of Equation (12).

The inter-frame correction vector V_{frame} is set as a representative vector (for example, a centroid vector of a bin) representing the bin s having the highest frequency, as shown in Equation (13).

V_{frame}=V_{bin}_{_{—}}ₛ|s=supₛ(Hist(s)) (13)

Here, V_{bin}_{_{—}}ₛ is a vector representing the respective bins, and s=supₛ (Hist(s)) is the number s of the bin having the highest frequency.

FIG. 8 is a flowchart of correction vector calculation processing for integrating a plurality of motion vectors through histogram processing. Here, histogram processing is only performed for a block i having a reliability that is equal to or greater than the threshold S_Thr and a contribution that is equal to or greater than the threshold K_Thr. Therefore, a determination is made in a step S51 as to whether or not the reliability Si is equal to or greater than the threshold S_Thr, and a determination is made in a step S52 as to whether or not the contribution Ki is equal to or greater than the threshold K_Thr. Motion vectors Vi in which the reliability Si is smaller than the threshold S_Thr or the contribution Ki is smaller than the threshold K_Thr are excluded from the histogram processing. In a step S53, the histogram processing described above is performed such that the motion vectors Vi are allocated to the bins. By repeating the steps S51 to S53, a histogram is created. In a step S54, the representative vector representing the bin having the highest frequency is set as the inter-image correction vector, as described above.

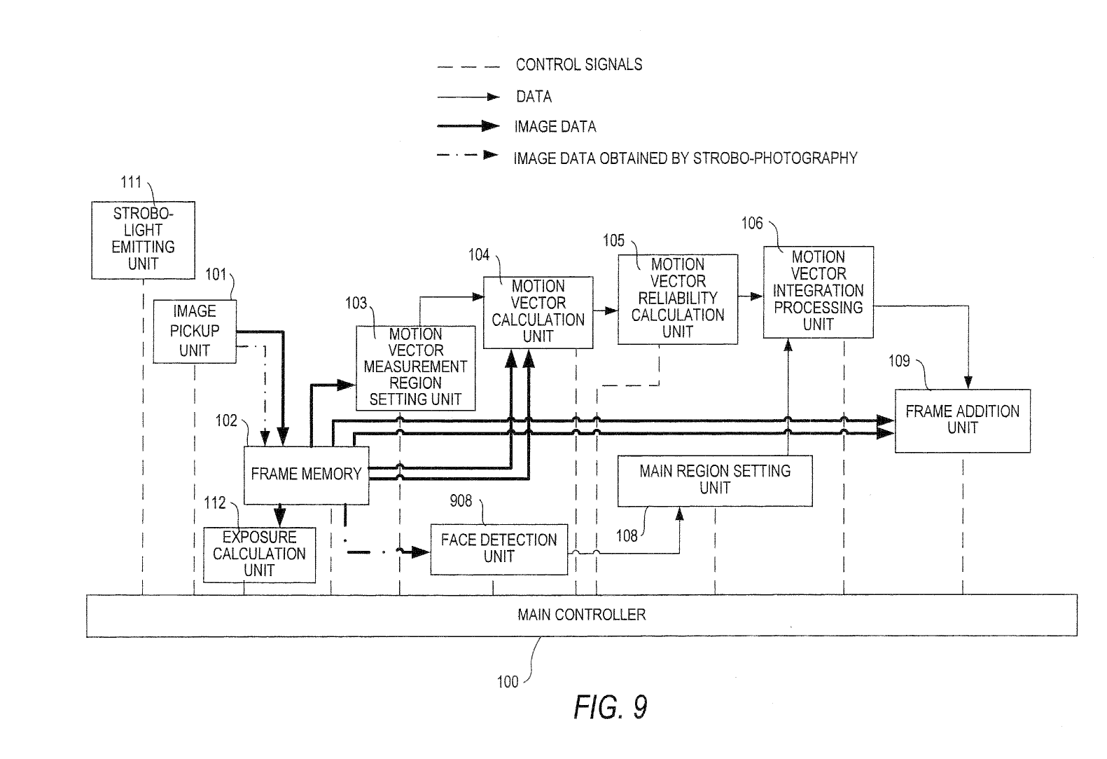

Next, referring to FIG. 9, a third embodiment will be described. In the third embodiment, the main region is a region including a human face. A face detection unit (face detecting means) 908 for detecting a human face is used as the main region detection unit. The face detection unit 908 calculates a block 1003 that overlaps the region of the human face in the image obtained when the strobo-light emitting unit 111 emits strobo-light. A method and an application thereof described in Paul Viola, Michael Jones: Robust Realtime Object Detection, Second International Workshop on Statistical and Computational Theories of Vision-Modeling, Learning, Computing and Sampling 2001, for example, are used as a method of detecting a face region 1002. Using the algorithm of this method, the position and size of the face can be calculated. It should be noted that face detection may be performed using another method.

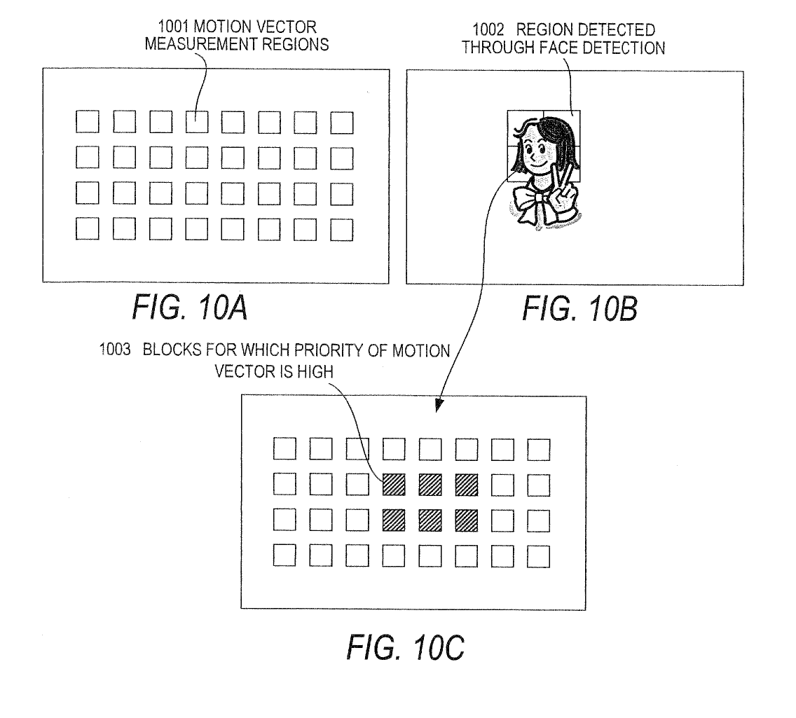

FIG. 10A shows a motion vector measurement region 1001 set by the region setting unit 103. FIG. 10B shows a region 1002 detected through face detection. As shown in FIG. 10C, by integrating two sets of information relating to motion vector measurement and face detection, a correction vector is calculated. Motion vector data in the block 1003 corresponding to the face region are taken into account particularly preferentially. To calculate the contribution, the method shown in FIGS. 4 and 5 or a method taking into account the area of overlap in the regions may be used. The integration calculation shown in FIG. 6 is performed taking into consideration the reliability of the motion vector and the contribution, which is calculated from the positional relationship between the face region and the motion vector measurement region, and thus the inter-frame correction vector is calculated (Equation (9)).

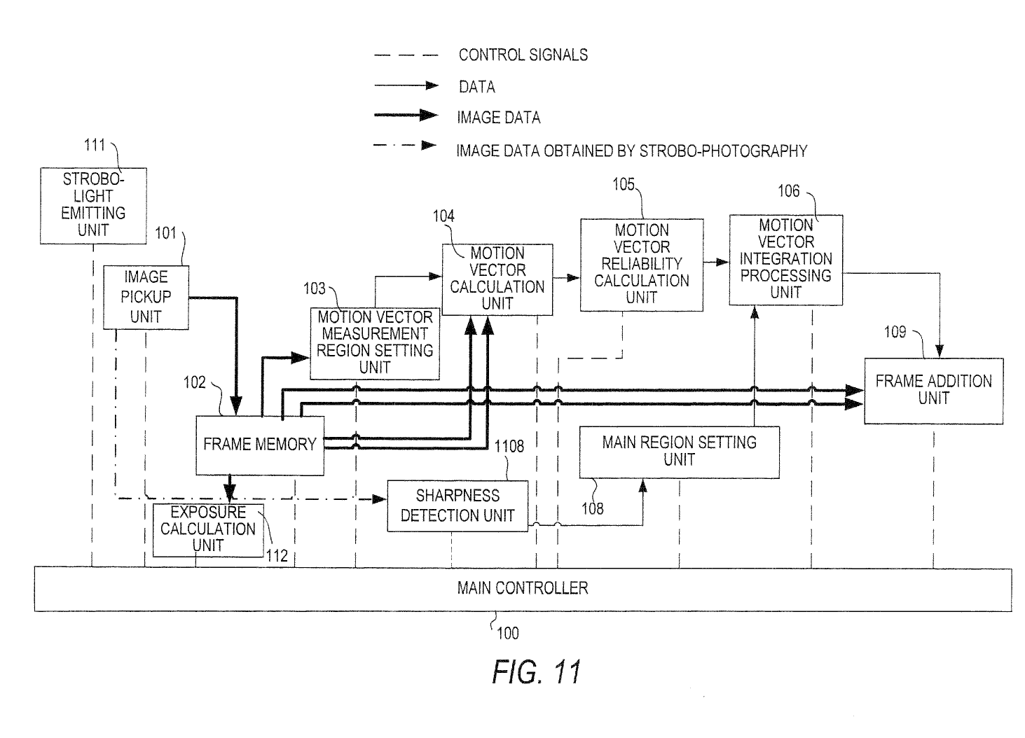

Next, referring to FIG. 11, a fourth embodiment will be described. In the fourth embodiment, the main region of the image obtained through strobo-photography is a region having a high degree of sharpness, and therefore a sharpness detection unit (contrast detection unit) 1108 employed in Imager AF is used as the main region detection unit. Filtering means (a differential filter or the like) for detecting an edge feature quantity (for example, a difference between pixel values of adjacent pixels) are used to detect the sharpness. The sharpness may correspond to a contrast value (for example, a total sum of the absolute value of a difference between pixel values of the adjacent pixels of the same color). A block region of the reference frame in which the sharpness is equal to or greater than a predetermined value may be set as the main region.

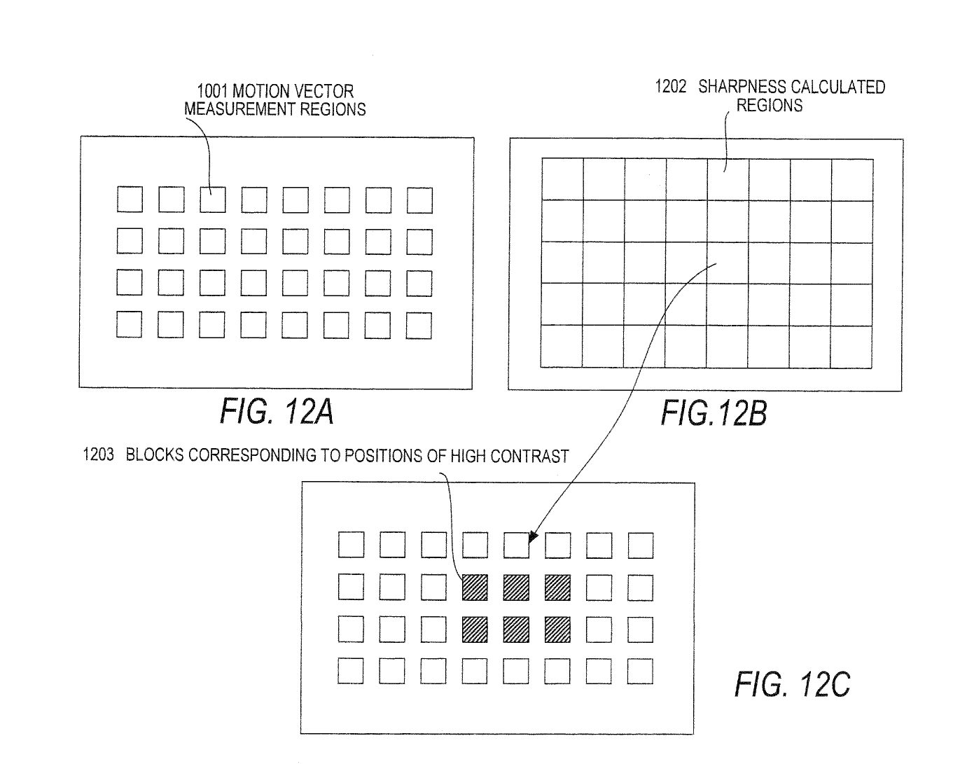

FIG. 12A shows the motion vector measurement regions 1001 set by the region setting unit 103. FIG. 12B shows a plurality of regions 1202 in which sharpness detection is performed. As shown in FIG. 12C, by integrating two sets of information relating to motion vector measurement and sharpness measurement, a correction vector is calculated. Motion vector data in the regions 1203 in which the sharpness is high are taken into account particularly preferentially. To calculate the contribution, the method shown in FIGS. 4 and 5 or a method taking into account the area of overlap in the regions may be used. The integration calculation shown in FIG. 6 is performed taking into consideration the reliability of the motion vector and the contribution, which is calculated from the positional relationship between the regions having high contrast and the motion vector measurement regions, and thus the inter-frame correction vector is calculated (Equation (9)).

This invention is not limited to the embodiments described above, and may of course be subjected to various modifications within the scope of the technical spirit thereof.

The entire contents of JP2008-28029A, filed on Feb. 7, 2008, are incorporated into this specification by reference.

What is claimed is:

1. An image pickup apparatus that performs image registration processing between a plurality of images through a motion vector calculation, comprising:
an exposure calculation unit for calculating an exposure when an object is photographed;
a flash photography unit for performing image pickup of one of the plurality of images by causing a flash device to emit light during the image pickup in accordance with the exposure;
a motion vector measurement region setting unit for setting a plurality of motion vector measurement regions for which a motion vector is measured;
a motion vector calculation unit for calculating the motion vectors of the plurality of motion vector measurement regions;
a motion vector reliability calculation unit for calculating a reliability of the respective motion vectors;
a main region detection unit for detecting a main region from the image photographed by the flash photography unit; and
a motion vector integration processing unit for calculating an inter-image correction vector on the basis of the motion vectors of the plurality of motion vector measurement regions, taking into account the reliability,
wherein the motion vector integration processing unit includes a contribution calculation unit for calculating a contribution of the respective motion vectors from a positional relationship between the respective motion vector measurement regions and the main region, and integrates the motion vectors of the plurality of motion vector measurement regions in accordance with the reliability and the contribution.

2. The image pickup apparatus as defined in claim 1, wherein the flash photography unit causes the flash device to emit light when the exposure is equal to or smaller than a threshold.

3. The image pickup apparatus as defined in claim 1, wherein the motion vector integration processing unit calculates the inter-image correction vector by setting a weighting coefficient in accordance with the reliability and the contribution and subjecting the motion vectors of the plurality of motion vector measurement regions to weighted addition in accordance with the weighting coefficient.

4. The image pickup apparatus as defined in claim 3, wherein, when the reliability calculated by the motion vector reliability calculation unit is smaller than a threshold, the motion vector integration processing unit resets the reliability to zero.

5. The image pickup apparatus as defined in claim 3, wherein, when a motion vector of an ith motion vector measurement region is represented by Vi, the reliability thereof is represented by STi, and the contribution thereof is represented by Ki, the motion vector integration processing unit calculates the weighting coefficient of the motion vector of the ith motion vector measurement region on the basis of a product of the reliability STi and the contribution Ki, and calculates the correction vector V_{Frame} using a following equation
$${V}_{Frame} = \frac{1}{ΣSTiK} ΣSTi \cdot Ki \cdot Vi$$

6. The image pickup apparatus as defined in claim 1, wherein the motion vector integration processing unit performs histogram processing on a motion vector selected in accordance with the reliability and the contribution, and sets a representative vector of a bin having a maximum frequency as the inter-image correction vector.

7. The image pickup apparatus as defined in claim 1, wherein, when a central coordinate of the motion vector measurement region is included in the main region, the contribution is set to be large, and when the central coordinate of the motion vector measurement region is not included in the main region, the contribution is set to be small.

8. The image pickup apparatus as defined in claim 1, wherein the contribution is set to be larger as an area of overlap between the motion vector measurement region and the main region increases.

9. The image pickup apparatus as defined in claim 1, wherein the contribution decreases as a distance between the motion vector measurement region and the main region increases.

10. The image pickup apparatus as defined in claim 1, wherein the main region setting unit detects a specific object region of an image and sets the main region on the basis of the detected specific object region.

11. The image pickup apparatus as defined in claim 1, wherein the main region setting unit detects a sharpness of an image and sets the main region on the basis of the sharpness.

12. An image pickup method for performing image registration processing between a plurality of images through a motion vector calculation, comprising:
an exposure calculation step for calculating an exposure when an object is photographed;
a flash photography step for performing image pickup of one of the plurality of images by causing a flash device to emit light during the image pickup in accordance with the exposure;
a motion vector measurement region setting step for setting a plurality of motion vector measurement regions for which a motion vector is measured;
a motion vector calculation step for calculating the motion vectors of the plurality of motion vector measurement regions;
a motion vector reliability calculation step for calculating a reliability of the respective motion vectors;
a main region detection step for detecting a main region from the image photographed in the flash photography step; and
a motion vector integration processing step for calculating an inter-image correction vector on the basis of the motion vectors of the plurality of motion vector measurement regions taking into account the reliability,
wherein the motion vector integration processing step includes a contribution calculation step for calculating a contribution of the respective motion vectors from a positional relationship between the respective motion vector measurement regions and the main region, and in the motion vector integration processing step, the motion vectors of the plurality of motion vector measurement regions are integrated in accordance with the reliability and the contribution.
